(19) United States
(12) Patent Application Publication
(10) Pub. No.: US 2006/0047565 A1
(43) Pub. Date: Mar. 2, 2006

(54) System and method for providing diagnostic information through the decomposition of metrics

(75) Inventors: Michael Gilfix, Austin, TX (US); David Perry Greene, Austin, TX (US); Vani Prasad, Austin, TX (US); Daniel R. Roth, Somerville, MA (US); William R. Salinas, Pittsburgh, PA (US); William Streit, Cedar Park, TX (US)

Correspondence Address: Gregory W. Carr, 670 Founders Square, 900 Jackson Street, Dallas, TX, 75202, US

(73) Assignee: International Business Machines Corporation, Armonk, NY (US)

(21) Appl. No.: 10/926,588

(22) Filed: Aug. 26, 2004

(51) Int. Cl. H04M 3/51; G06T 1/00

(52) U.S. Cl. 705/11; 345/418

(57) ABSTRACT

The present invention provides decomposing metrics. A result is decomposed into a expression and at least one datum. The decomposed expression and at least one datum is rendered on a display means. This enables and end user to determine what calculations and data is used to calculate metrics, thereby giving the viewer more useful information.

### TECHNICAL FIELD

The invention relates generally to metrics and, more particularly, to the decomposition of metrics.

### BACKGROUND

There are a variety of metrics that can be used to measure productivity in the workplace. One of these measurements is known as a dashboard. Specifically, a dashboard is a tool for visualizing measurements (that is, making the measurements visible) and also provides an infrastructure for gathering the data needed to calculate those measurements. It can use bars or graphs or other forms of graphical data interpretations. Generally, a dashboard is designed to provide executives or other interested parties with a compressed, high level view of a business through providing the representation of various performance indicators distilled from large collections of data.

For instance, a dashboard could be used in telephone support. The dashboard could show an end user the average length of time a caller is on hold, the average time that a call takes to be processed by an operator, the number of calls that hang up before being processed by an operator. This information could be displayed graphically as charts or figures to the end user, and updated periodically.

However, there are problems associated with conventional dashboards. One problem is that the user is unaware of how a given metric has been obtained, that is, the nature of the data from which it is calculated. Furthermore, little or no guidance is given as to how the various indicators are derived. If the end user wishes to understand these key indicators, there is not a method or system that allows the end user to determine this.

Therefore, there is a need for a dashboard that allows an end user access to the calculation of various indices that addresses at least some of the problems associated with conventional dashboards.

### SUMMARY OF THE INVENTION

The present invention provides decomposing metrics. A result is decomposed into a expression and at least one datum. The decomposed expression and at least one datum is rendered on a display means.

### BRIEF DESCRIPTION OF THE DRAWINGS

For a more complete understanding of the present invention, and the advantages thereof, reference is now made to the following Detailed Description taken in conjunction with the accompanying drawings, in which:

FIG. 1 schematically depicts a network in which the metric information can be used, decomposed and displayed; and

FIG. 2 schematically illustrates a system in which metric decomposition can occur.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

In the remainder of this description, a processing unit (PU) may be a sole processor of computations in a device. In such a situation, the PU is typically referred to as an MPU (main processing unit). The processing unit may also be one of many processing units that share the computational load according to some methodology or algorithm developed for a given computational device. For the remainder of this description, all references to processors shall use the term MPU whether the MPU is the sole computational element in the device or whether the MPU is sharing the computational element with other MPUs, unless otherwise indicated.

It is further noted that, unless indicated otherwise, all functions described herein may be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

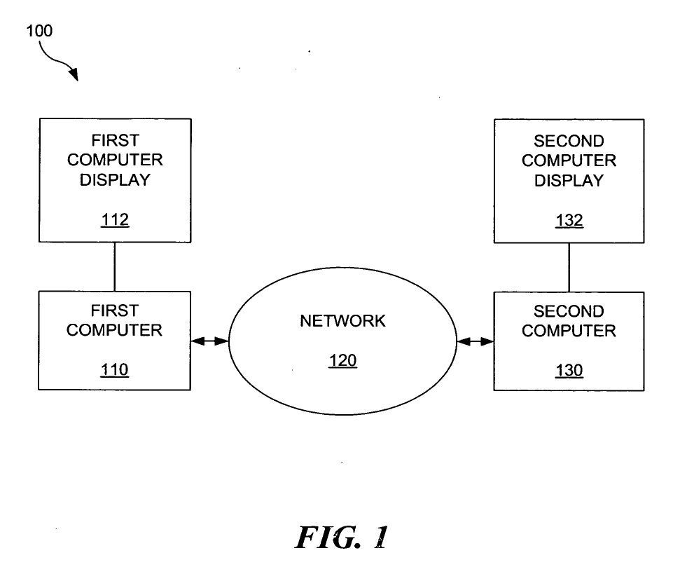

Turning to FIG. 1, disclosed is an environment 100 in which metric decomposition can execute. A first computer 110 is coupled through a network 120 to a second computer 130. The first computer 110 is coupled to a first monitor 112. The second computer 130 is coupled to a second monitor 132. Generally, the system 100 is directed to enabling the decomposition of a high level metric or key indicator values calculation into its constituent parts, and the constituent parts are displayed on the monitors 112, 132.

Among other things, a metric can be defined as one or more calculations that provide a mathematical result, which in its final data form is intelligible to humans, that is then used to drive a Graphical User Interface (GUI) representation. In the system 100, such as within the network 120, as more final data becomes available, the metrics are periodically re-evaluated (that is, the mathematical expressions that comprise the metric are re-calculated), and the GUI is updated.

Generally, decomposing a metric enables a reviewer to be able to understand how various values and metrics are calculated and come into being. In other words, the end user is able to review both the data used in the calculations, and the calculations themselves, and have this information displayed on the displays 112, 132. This enables executives or other end users to have a further grasp of the depth analysis of their businesses. Implementation costs for dashboards can be reduced by building high level and low level analysis tools simultaneously to allow for decomposition into metrics. The metric decomposition can occur in the first computer 110, the second computer 130, or the network 120, or elsewhere as appropriate.

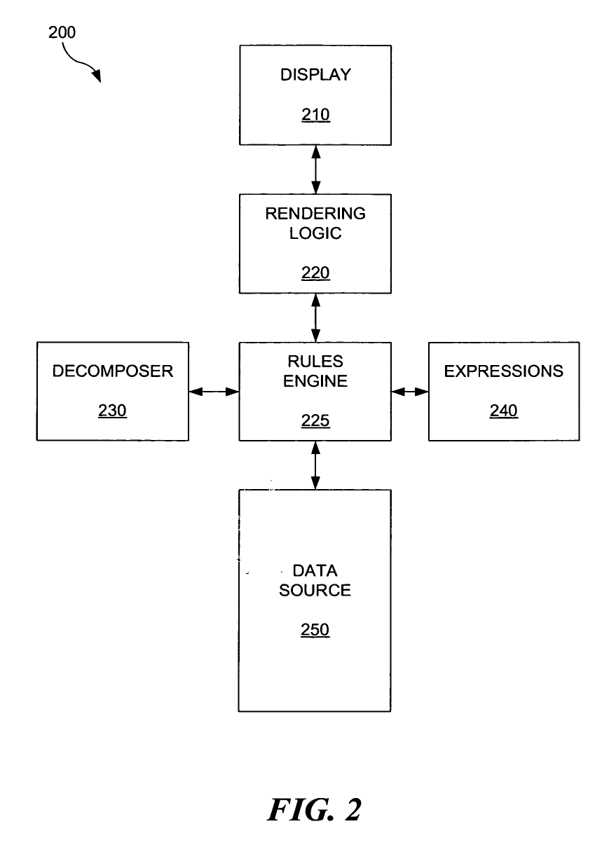

Turning now to FIG. 2, disclosed is one logical arrangement of how decompositions can be performed in a system. A display 210, such as a monitor, is coupled to a processor which has rendering logic 220. The rendering logic 220 is further coupled to a rules engine 225. The rules engine 225 is coupled to a decomposer 230 and a memory for expressions 240. The rules engine 225 is also coupled to a data source 250.

The rendering logic 220 illustrates the metric requested by the end user, and does not play a part in the actual performance of the system. In FIG. 2, the rules engine 225 combines expressions (such as how to perform a statistical calculation) from the expression memory 240 to data in the data source 250, thereby generating a value which is rendered by the rendering logic 220 on the display 210. However, the decomposer 230 can look at both the calculation from the expression memory 240 and the data from the data source 250. The decomposer 230 can then order the rendering logic 220 to display on display 210 hierarchy of how the metrics, seen by the end user, are derived.

In the system 200, mathematical expressions are stored within a rules engine in symbolic form (that is, $a+($b/$c)), where perhaps ($b/$c) is an important and meaningful sub-product. The rules engine 225 then takes data from the data source 250 and evaluates the symbolic mathematical expressions from the expressions memory 240, such as a substitution. Since the expression is stored within the expression memory 240, the expressions can be dissected to extract sub-expressions that could be very meaningful and helpful when looking at the high-level analysis on he display 210. To obtain this value, in one embodiment, a re-computation of the sub-expression commences. In another embodiment, a rules engine that has cached the intermediary result is selected for displaying the result on the display 210.

For instance, suppose that we have a metric that shows “average sales per customer.” That is all well and fine, but how does the end user know how this was calculated? As it turns out, “average sales per customer” was calculated in the following manner:
Average Sales per Customer=Average Sales/Number of Customers

But, where do Average Sales and Number of Customers information come from?

This can be then shown to be the following:
Average Sales=SUM sales/COUNT sales;
Number of Customers=COUNT customers;
where the operators SUM and COUNT do exactly that within the defined field.

The decomposer 230 shows the above expression to give the end user more of an idea of where the calculation of average sales per customer derives. The actual expression for this metric is therefore:
Average sales per customer=(SUM sales)*(COUNT sales)/(COUNT customers).

The decomposition of average sales per customer into the above specific logical expressions, which are retrievable by the end user, are of great assistance to the end user, as he can determine how the expressions which are used to generate the data are applied. Furthermore, if there is a case where an expression is using as inputs the output of other expressions, this can also be decomposed for the use of the end user.

For instance, if there was a metric showing “calculated overall customer satisfaction”, it could be worked as follows. Overall customer satisfaction could be naively calculated as combination of the number of complaints received divided by the average sales per customer, above. However, there could be cases wherein the complaints were only being generated by very small purchasers, or very large ones; alternatively, complaints could be generated by only those who are not buying. Furthermore, perhaps for business reasons, as market exposure goes up, complaints go up as well proportionately, but the sales are not finalized until 60 days after delivery, for example. The decomposition of the system 200 by the composer 230 could allow an executive to decompose metrics like “calculated overall customer satisfaction” to determine exactly how the metric was calculated, and how germane that information is to this particular situation.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A system for displaying metrics, comprising:
a display means;
a rendering means coupled to the display means;
a rules engine coupled to the rendering logic;
a decomposer coupled to the rules engine;
an expression memory coupled to the rules engine; and
a data source coupled to the rules engine.

2. The system of claim 1, wherein the rendering logic is configured to accept commands from the decomposer.

3. The system of claim 1, wherein the decomposer is configured to decompose an expression into its constituent data and mathematical expression.

4. The system of claim 1, wherein the decomposer is further configured to order the display of the constituent data and mathematical expressions.

5. The system of claim 1, where the constituent data and mathematical expressions are further decomposed into constituent data and mathematical expressions.

6. The system of claim 5, wherein the constituent decompositions are arranged in a hierarchy.

7. The system of claim 6, wherein the hierarchy is displayed upon the display means.

8. The system of claim 1, wherein the display means comprises a business dashboard.

9. The system of claim 1, wherein the data source is configured to be updated with new data.

10. The system of claim 1, further comprising a plurality of dada within the data source.

11. The system of claim 1, wherein the display means comprises a monitor.

12. A method of decomposing metrics, comprising:
decomposing a result into a expression;
decomposing a result into at least one datum; and
rendering the decomposed expression and at least one datum on a display means.

13. The method of claim 12, further comprising further decomposing the decomposed expression.

14. The method of claim 13, further comprising arranging the decomposed expressions and the at least one datum into a hierarchy.

15. The method of claim 14, further comprising rendering the hierarchy on the display means.

16. The method of claim 12, further comprising updating the at least one datum.

17. The method of claim 16, further comprising displaying the updated datum on the display means.

18. The method of claim 12, further comprising decomposing the at least one datum.

19. A computer program product for decomposing metrics, the computer program product having a medium with a computer program embodied thereon, the computer program comprising:
computer code for decomposing a result into a expression;
computer code for decomposing a result into at least one datum; and
computer code for rendering the decomposed expression and at least one datum on a display means.

20. A processor for decomposing metrics, the processor including a computer program comprising:
computer code for decomposing a result into a expression;
computer code for decomposing a result into at least one datum; and
computer code for rendering the decomposed expression and at least one datum on a display means.
